(19) United States
(12) Patent Application Publication
(10) Pub. No.: US 2025/0146530 A1
(43) Pub. Date: May 8, 2025

(54) BALL BEARING

(71) Applicant: NTN CORPORATION, Osaka (JP)

(72) Inventors: Yasuhiro KANBORI, Shizuoka (JP); Yuta MOCHIZUKI, Shizuoka (JP); Yuuki HASHIZUME, Shizuoka (JP); Takufumi SATO, Shizuoka (JP)

(73) Assignee: NTN CORPORATION, Osaka (JP)

(21) Appl. No.: 18/835,528

(22) PCT Filed: Jan. 30, 2023
(86) PCT No.: PCT/JP2023/002827

§ 371 Date: Aug. 2, 2024

(30) Foreign Application Priority Data
Feb. 4, 2022 (JP) 2022-016439

(51) Int. Cl. F16C 33/42; B21D 53/12; F16C 19/06

(52) U.S. Cl. CPC F16C 33/422; B21D 53/12; F16C 19/06

(57) ABSTRACT

Each second rivet hole has an inner periphery constituted by a cylindrical shear surface having a constant inner diameter that does not axially change; and a tapered fracture surface gradually radially expanding from the shear surface toward an abutment surface.

### TECHNICAL FIELD

The present invention relates to a ball bearing.

### BACKGROUND ART

As bearings that support rotary shafts of, e.g., automotive transmissions, ball bearings are used. Ball bearings include an inner ring; an outer ring arranged radially outwardly of, and coaxially with, the inner ring; a plurality of balls disposed in the annular space between the inner ring and the outer ring; and a cage retaining the balls.

As such a cage, an iron plate rivet crimping cage is known (e.g., in the below-identified Patent Document 1), which is excellent in cost and productivity. The iron plate rivet crimping cage is constituted by a first annular member and a second annular member formed by pressing a steel plate and axially opposed to each other; and a plurality of rivets coupling the first and second annular members together. The first annular member includes arc-shaped first pocket wall portions receiving the balls; and first flat plate portions circumferentially alternating with the first pocket wall portions, and each having a first rivet hole axially extending through the first annular member. Similarly, the second annular member also includes arc-shaped second pocket wall portions receiving the balls; and second flat plate portions circumferentially alternating with the second pocket wall portions, and each having a second rivet hole axially extending through the second annular member.

Each rivet includes a rivet shaft; a pre-formed head formed beforehand at one end of the rivet shaft; and a crimped head formed by crimping the other end of the rivet shaft. The rivet shaft is inserted through the first rivet hole of the first flat plate portion and the second rivet hole of the second flat plate portion with the first and second flat plate portions superposed on each other. The pre-formed head and the crimped head are disposed such that the first and second flat plate portions are axially sandwiched therebetween. The first flat plate portion is axially engaged with the pre-formed head, and the second flat plate portion is axially engaged with the crimped head.

### PRIOR ART DOCUMENT(S)

### Patent Document(s)

Patent Document 1: Japanese Unexamined Patent Application Publication No. 2017-110784

### SUMMARY OF THE INVENTION

### Problems to be Solved by the Invention

The above iron plate rivet crimping cage can be assembled as follows: First, the first annular member is prepared, and the rivets are press-fitted into the respective first rivet holes in the first flat plate portions of the first annular member. At this time, each rivet press-fitted in the first rivet hole is fixed to the first annular member by the interference between its rivet shaft and the first rivet hole. Also, the rivet shaft of each rivet protrudes beyond an abutment surface of the first flat plate portion against the second flat plate portion. Thereafter, the first annular member is superposed onto the second annular member such that a plurality of balls disposed between the inner ring and the outer ring so as to be circumferentially equidistantly spaced apart from each other are each sandwiched from both axial sides by the first pocket wall portion of the first annular member and the second pocket wall portion of the second annular member. At this time, the rivets partially protruding beyond the first annular member are inserted into the respective second rivet holes of the second annular member. Last, the portion of each rivet shaft that has passed through the second rivet hole is axially crushed and crimped by a crimping die, so that crimped heads are formed and the first annular member and the second annular member are coupled together. In some cases, a surface treatment (such as a soft nitriding treatment) is conducted to the first and second annular members for the purpose of improving the wear resistance and strength of the cage. In this case, the surface treatment is conducted before the first annular member is superposed onto the second annular member.

If the iron plate rivet crimping cage is assembled as described above, when the first annular member is superposed onto the second annular member, the rivet shafts partially protruding beyond the first annular member need to be inserted into the respective second rivet holes of the second annular member. However, it is difficult to circumferentially and radially align the positions of the rivet shafts on the side of the first annular member with the positions of the respective second rivet holes on the side of the second annular member, and thus the above insertion is difficult.

In order to easily insert the rivets partially protruding beyond the first annular member into the respective second rivet holes of the second annular member, it is considered that after forming a plurality of second rivet holes axially extending through the second annular member, tapered chamfers are formed at the edges of the second rivet holes, and the tapered chamfers are used as guiding surfaces for the rivet shafts. However, it costs a lot to form chamfers at the second rivet holes.

It is an object of the present invention to provide a ball bearing including an iron plate rivet crimping cage having excellent assemblability.

### Means for Solving the Problems

The inventors of the present application focused on the point that with respect to formation of the second rivet holes of the second annular member, if second rivet holes are formed by punching using a punch, a cylindrical shear surface having a constant inner diameter that does not change in the axial direction; and a fracture surface connected to the shear surface are formed on the inner periphery of each second rivet hole, and the fracture surface is a tapered surface. Then, the inventors came up with the idea that the tapered fracture surfaces are used as guiding surfaces for the rivet shafts when assembling the iron plate rivet crimping cage.

Bases on this idea, as a means for achieving the above object, the present invention provides a ball bearing comprising: an inner ring; an outer ring arranged radially outwardly of, and coaxially with, the inner ring; a plurality of balls disposed between the inner ring and the outer ring so as to be circumferentially spaced apart from each other; and an iron plate rivet crimping cage retaining the balls, wherein the iron plate rivet crimping cage includes: a first annular member formed of a steel plate; a second annular member formed of a steel plate, and axially opposed to the first annular member; and a plurality of rivets coupling the first annular member and the second annular member together, wherein the first annular member includes: arc-shaped first pocket wall portions receiving the respective balls; and first flat plate portions disposed to circumferentially alternate with the first pocket wall portions, and each having a first rivet hole axially extending through the first annular member, and, wherein the second annular member includes: arc-shaped second pocket wall portions receiving the respective balls; and second flat plate portions disposed to alternate with the second pocket wall portions, and each having: a second rivet hole axially extending through the second annular member; and, an abutment surface against a corresponding one of the first flat plate portions, and wherein each of the rivet includes: a rivet shaft inserted through a corresponding one of the first rivet holes of the first flat plate portions and a corresponding one of the second rivet holes of the second flat plate portions; a pre-formed head formed at one end of the rivet shaft, and axially engaged with the corresponding one of the first flat plate portions; and a crimped head formed by crimping the other end of the rivet shaft, and axially engaged with a corresponding one of the second flat plate portions, characterized in that each of the second rivet holes has an inner periphery constituted by: a cylindrical shear surface having a constant inner diameter that does not axially change; and a tapered fracture surface gradually radially expanding from the shear surface toward a corresponding one of the abutment surfaces of the second flat plate portions.

With this arrangement, since each second rivet hole, which axially extends through the second flat plate portion, has an inner periphery constituted by a cylindrical shear surface having a constant inner diameter that does not change in the axial direction; and a tapered fracture surface that gradually radially expands from the shear surface toward the abutment surface of the second flat plate portion against the first flat plate portion, when each rivet shaft is inserted into the second rivet hole, the tapered fracture surface functions as a guiding surface for the rivet shaft, thus facilitating the insertion of the rivet shaft into the second rivet hole. Therefore, the iron plate rivet crimping cage has excellent assemblability. Also, by punching, with a punch, each second flat plate portion from the side opposite from the abutment surface of the second flat plate portion against the first flat plate portion toward the abutment surface of the second flat plate portion against the first flat plate portion, it is possible to form a tapered fracture surface that gradually radially expands toward the abutment surface of the second flat plate portion against the first flat plate portion. Since, when the second rivet holes are formed to axially extend through the respective second flat plate portions, the tapered fracture surfaces are simultaneously formed on the inner peripheries of the second rivet holes, the number of machining steps is small and the cost is low.

A nitrided layer may be formed on a surface of the first annular member and a surface of the second annular member.

In this case, the nitrided layer may be formed on the entire inner peripheries of the second rivet holes, and an inner periphery of each of the first rivet holes may have a non-nitrided surface that is not formed with the nitrided layer.

The above structure is obtained when a soft nitriding treatment is conducted using the following method: First, the rivets are press-fitted into the respective first rivet holes of the first annular member that has not been subjected to a soft nitriding treatment yet. Next, a soft nitriding treatment is conducted to the rivets and the first annular member that are now integrally combined together due to the press fitting. At this time, a nitrided layer is formed on the surface of the first annular member by the soft nitriding treatment, but the inner periphery of each first rivet hole (fitting surface thereof to which the rivet shaft is fitted) is masked by the rivet shaft, and thus has a non-nitrided surface formed with no nitrided layer. Thereafter, by superposing the first annular member onto the second annular member that has now been subjected to a soft nitriding treatment; and crimping the portions of the rivet shafts protruding beyond the second rivet holes of the second annular member, the first and second annular members are coupled together.

If a soft nitriding treatment is conducted using this method, since the rivets are press-fitted into the respective first rivet holes of the first annular member of which the surface has not been subjected to a soft nitriding treatment and hardened yet, the press fitting of the rivets is easy.

As with the inner peripheries of the second rivet holes, the inner periphery of each of the first rivet holes may be constituted by: a cylindrical shear surface having a constant inner diameter that does not axially change; and a tapered fracture surface gradually radially expanding from the shear surface of the first rivet hole toward a corresponding one of abutment surfaces of the first flat plate portions against the respective second flat plate portions. In this case, L>2t/3 is preferably satisfied, where L is an axial length of the shear surface of the inner periphery of the first rivet hole of each of the first flat plate portions, and t is a thickness of the each of the first flat plate portions.

With this arrangement, when each rivet is inserted into the first rivet hole, it is possible to ensure a fitting area where the outer periphery of the rivet shaft of the rivet and the inner periphery of the first rivet hole are fitted to each other with interference. Therefore, after each rivet is press-fitted into the first rivet hole, before the portion of the rivet shaft of the rivet protruding beyond the first rivet hole is inserted into the second rivet hole, it is possible to prevent pullout of the rivet from the first rivet hole due to, e.g., vibrations or shocks received from the outside. The first annular member and the second annular member may be formed of a cold-rolled steel plate.

The above ball bearing may be used as a bearing supporting a rotary shaft of one of an automotive transmission, an automotive engine accessory, a running motor of an electric vehicle and a speed reducer for reducing a rotational speed of a running motor of an electric vehicle.

### Effects of the Invention

For the ball bearing of the present invention, since each second rivet hole, which axially extends through the second flat plate portion, has an inner periphery constituted by a cylindrical shear surface having a constant inner diameter that does not change in the axial direction; and a tapered fracture surface that gradually radially expands from the shear surface toward the abutment surface of the second flat plate portion against the first flat plate portion, when each rivet shaft is inserted into the second rivet hole, the tapered fracture surface functions as a guiding surface for the rivet shaft, thus facilitating the insertion of the rivet shaft into the second rivet hole. Therefore, the iron plate rivet crimping cage has excellent assemblability. Also, by punching, with a punch, each second flat plate portion from the side opposite from the abutment surface of the second flat plate portion against the first flat plate portion toward the abutment surface of the second flat plate portion against the first flat plate portion, it is possible to form a tapered fracture surface that gradually radially expands toward the abutment surface of the second flat plate portion against the first flat plate portion. Since, when the second rivet holes are formed to axially extend through the respective second flat plate portions, the tapered fracture surfaces are simultaneously formed on the inner peripheries of the second rivet holes, the number of machining steps is small and the cost is low.

### BRIEF DESCRIPTION OF THE DRAWINGS

FIG. 1 is a sectional view of a ball bearing embodying the present invention.

FIG. 2 is a sectional view of an iron plate rivet crimping cage in FIG. 1 taken along a cylindrical surface including a pitch circle (imaginary circle connecting the centers of a plurality of circumferentially disposed balls).

FIG. 3 is a sectional view showing a state right before first and second annular members in FIG. 2 are superposed onto each other.

FIG. 4 is an enlarged sectional view of a first rivet hole in FIG. 3 and the vicinity thereof, the enlarged sectional view showing a state right before a rivet is press-fitted into the first rivet hole.

FIG. 5 is an enlarged sectional view of the first rivet hole in FIG. 4, a second rivet hole and the vicinities thereof, the enlarged sectional view showing a state in which after the rivet is press-fitted into the first rivel hole, the second annular member is opposed to the first annular member.

FIG. 6 is an enlarged sectional view of the first rivet hole, the second rivet hole and the vicinities thereof, the enlarged sectional view showing a state in which after the portion of a rivet shaft in FIG. 5 protruding beyond the first rivet hole is inserted into the second rivet hole, the portion of the rivet shaft protruding beyond the second rivet hole is crimped, thereby forming a crimped head.

FIG. 7 is an enlarged sectional view of the first rivet hole, the second rivet hole and the vicinities thereof, the enlarged sectional view showing a state in which the center of the rivet shaft in FIG. 5 and the center of the second rivet hole are displaced from each other.

FIG. 8A is a view showing a different example of the rivet in FIG. 5.

FIG. 8B is a view showing a still different example of the rivet in FIG. 5.

FIG. 9 is a perspective view of the iron plate rivet crimping cage in FIG. 2.

FIG. 10 is a sectional view of an automotive transmission in which a rotary shaft is supported by the ball bearing in FIG. 1.

FIG. 11A is a view showing analysis results of the stress acting on a first flat plate portion and a second flat plate portion in a case where a fracture surface is disposed at the end of the inner periphery of the first rivet hole closer to its abutment surface, and a fracture surface is disposed at the end of the inner periphery of the second rivet hole closer to its abutment surface.

FIG. 11B is a view showing analysis results of the stress acting on the first flat plate portion and the second flat plate portion in a case where a fracture surface is not disposed at the end of the inner periphery of the first rivet hole closer to its abutment surface, and a fracture surface is not disposed at the end of the inner periphery of the second rivet hole closer to its abutment surface.

### BEST MODE FOR CARRYING OUT THE INVENTION

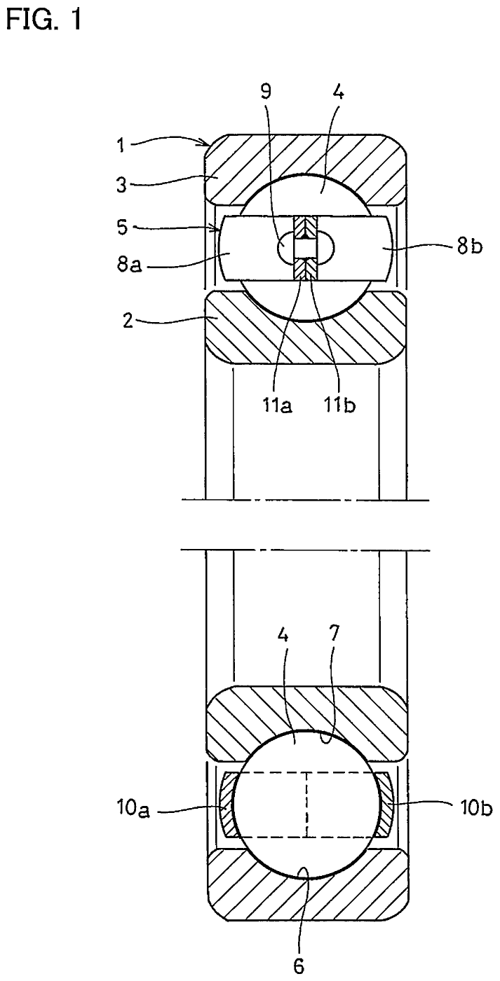

FIG. 1 illustrates a ball bearing according to an embodiment of the present invention. The ball bearing 1 includes an inner ring 2; an outer ring 3 arranged radially outwardly of, and coaxially with, the inner ring 2; a plurality of balls 4 disposed between the inner ring 2 and the outer ring 3 so as to be circumferentially spaced apart from each other; and an iron plate rivet crimping cage 5 (hereinafter simply referred to as the “cage 5”) that keeps the circumferential distances between the balls 4.

The outer ring 3 has, on its inner periphery, an outer ring raceway groove 6 with which the balls 4 come into rolling contact. The outer ring raceway groove 6 is a circular arc-shaped groove having a concave circular arc-shaped cross section, and extends circumferentially at the axial central portion of the inner periphery of the outer ring 3. The inner ring 2 also has, on its outer periphery, an inner ring raceway groove 7 with which the balls 4 come into rolling contact. The inner ring raceway groove 7 is a circular arc-shaped groove having a concave circular arc-shaped cross section, and extends circumferentially at the axial central portion of the outer periphery of the inner ring 2.

The balls 4 are radially sandwiched between the outer ring raceway groove 6 and the inner ring raceway groove 7. The ball bearing 1 is a deep groove ball bearing. That is, the outer ring raceway groove 6 is a circular arc-shaped groove symmetrical with respect to the axial center of the outer ring 3, and the inner ring raceway groove 7 is also a circular arc-shaped groove symmetrical with respect to the axial center of the inner ring 2. The outer ring raceway groove 6 has an axial width dimension larger than half of the diameter of each ball 4, and the inner ring raceway groove 7 also has an axial width dimension larger than half of the diameter of each ball 4.

The cage 5 includes a first annular member 8a formed of a steel plate; a second annular member 8b formed of a steel plate, and axially opposed to the first annular member 8a; and a plurality of rivets 9 coupling the first annular member 8a and the second annular member 8b together.

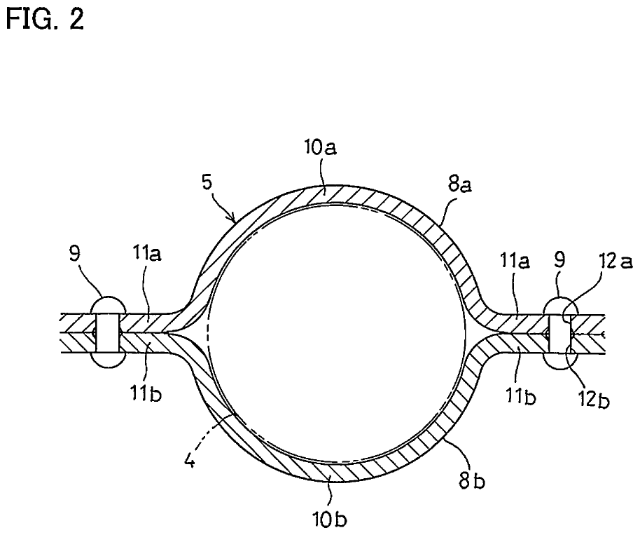

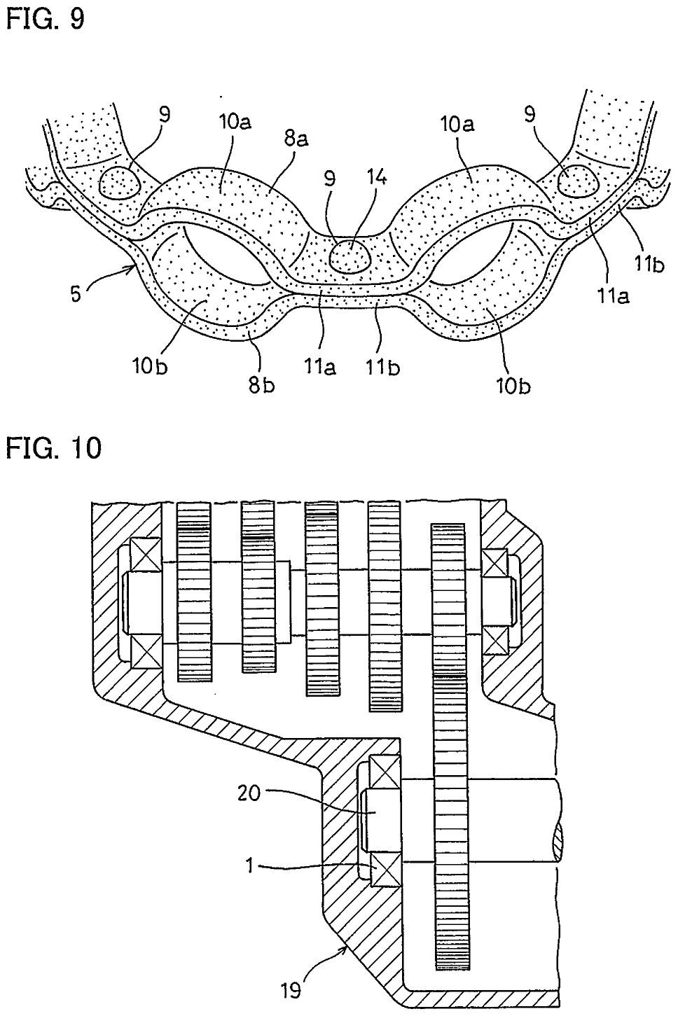

As illustrated in FIGS. 2 and 9, the first annular member 8a includes arc-shaped first pocket wall portions 10a that receive the balls 4; and flat plate-shaped first flat plate portions 11a that are orthogonal to the axial direction (vertical direction in the relevant drawings), and that alternate with the first pocket wall portions 10a in the circumferential direction (left-right direction in the relevant drawings). Similarly, the second annular member 8b also includes arc-shaped second pocket wall portions 10b that receive the balls 4; and flat plate-shaped second flat plate portions 11b that are orthogonal to the axial direction, and that alternate with the second pocket wall portions 10b in the circumferential direction. The first annular member 8a has the same shape and dimensions as the second annular member 8b.

As illustrated in FIG. 2, a first rivet hole 12a is formed in each first flat plate portion 11a of the first annular member 8a so as to axially extend through the first annular member 8a; a second rivet hole 12b is formed in each second flat plate portion 11b of the second annular member 8b so as to axially extend through the second annular member 8b; and a common rivet 9 is inserted in each first rivet hole 12a and the corresponding second rivet hole 12b.

The first pocket wall portions 10a and the first flat plate portions 11a are formed by pressing a cold-rolled steel plate (SPC material). The first rivet holes 12a are formed by punching the first flat plate portions 11a using a punch. Similarly, the second pocket wall portions 10b and the second flat plate portions 11b are also formed by pressing a cold-rolled steel plate. The second rivet holes 12b are formed by punching the second flat plate portions 11b using a punch. The rivets 9 are formed of a wire rod of carbon steel for machine structure, carbon steel for cold rolling or stainless steel.

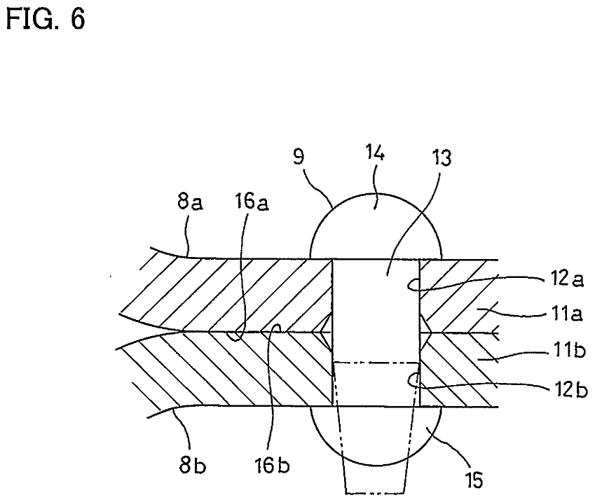

A nitrided layer is formed on the surface of the first annular member 8a by conducting a soft nitriding treatment, and a nitrided layer is also formed on the surface of the second annular member 8b by conducting a soft nitriding treatment. The “nitrided layer” is a surface-hardened layer having a hardness of 400 HV or more, and is an extremely thin chemical compound layer (compound layer comprising iron and nitrogen) having a thickness of 20 μm or less. A nitrided layer is formed on the entire inner periphery of each second rivet hole 12b shown in FIG. 6, whereas the inner periphery of each first rivet hole 12a has a non-nitrided surface formed with no nitrided layer.

As illustrated in FIG. 6, each rivet 9 includes a rivet shaft 13; a pre-formed head 14 formed beforehand at one end (upper end in FIG. 6) of the rivet shaft 13; and a crimped head 15 formed by crimping the other end (lower end in FIG. 6) of the rivet shaft 13. The rivet shaft 13 is inserted through the first and second rivet holes 12a and 12b with the first and second flat plate portions 11a and 11b superposed on each other. The pre-formed head 14 and the crimped head 15 are disposed such that the first and second flat plate portions 11a and 11b are axially (vertically in FIG. 6) sandwiched therebetween. The first flat plate portion 11a is axially engaged with the pre-formed head 14, and the second flat plate portion 11b is axially engaged with the crimped head 15.

The cage 5 can be manufactured as follows:

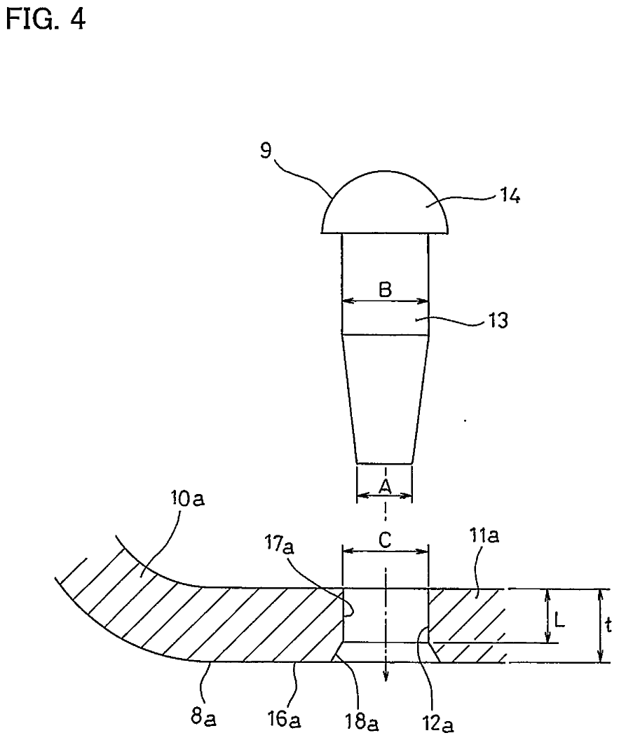

First, each first rivet hole 12a shown in FIG. 4 is formed in the first flat plate portion 11a of the first annular member 8a. The first rivet hole 12a is formed by punching, with a punch (not shown), the first flat plate portion 11a from the side opposite from an abutment surface 16a of the first flat plate portion 11a (that abuts) against the second flat plate portion 11b toward the abutment surface 16a of the first flat plate portion 11a (from the upper side toward the lower side in FIG. 4). The thus-formed first rivet hole 12a has an inner periphery constituted by a cylindrical shear surface 17a having a constant inner diameter that does not change in the axial direction; and a tapered fracture surface 18a that gradually radially expands from the shear surface 17a toward the abutment surface 16a. The shear surface 17a is a smooth surface having an axially extending striated pattern. On the other hand, the fracture surface 18a is an irregular, uneven surface created by tearing off the material of the first flat plate portion 11a. The fracture surface 18a has a surface roughness larger than that of the shear surface 17a.

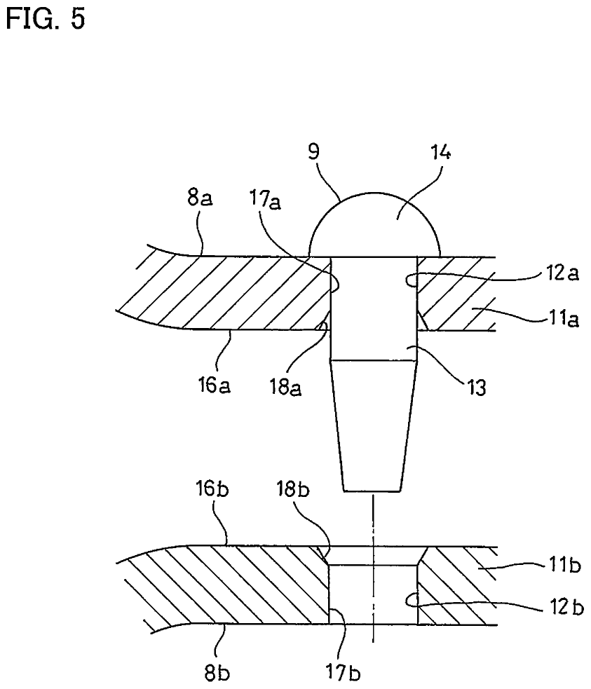

Also, as with the first rivet holes 12a, each second rivet hole 12a shown in FIG. 5 is formed in the second flat plate portion 11b of the second annular member 8b. The second rivet hole 12b is formed by punching, with a punch (not shown), the second flat plate portion 11b from the side opposite from an abutment surface 16b of the second flat plate portion 11b (that abuts) against the first flat plate portion 11a toward the abutment surface 16b of the second flat plate portion 11b (from the lower side toward the upper side in FIG. 5). The thus-formed second rivet hole 12b has an inner periphery constituted by a cylindrical shear surface 17b having a constant inner diameter that does not change in the axial direction; and a tapered fracture surface 18b that gradually radially expands from the shear surface 17b toward the abutment surface 16b. The fracture surface 18b has a surface roughness larger than that of the shear surface 17b. The second rivet hole 12b has the same shape and dimensions as the first rivet hole 12a.

Next, as illustrated in FIGS. 4 and 5, each rivet 9 is press-fitted into the first rivet hole 12a. The rivet 9 includes a rivet shaft 13, and a pre-formed head 14 formed beforehand at one end of the rivet shaft 13. The rivet shaft 13 is constituted by a cylindrical neck connected to the pre-formed head 14; and a tapered distal end portion radially compressed from the cylindrical neck toward the distal end of the rivet shaft 13. The pre-formed head 14 has a diameter larger than that of the rivet shaft 13.

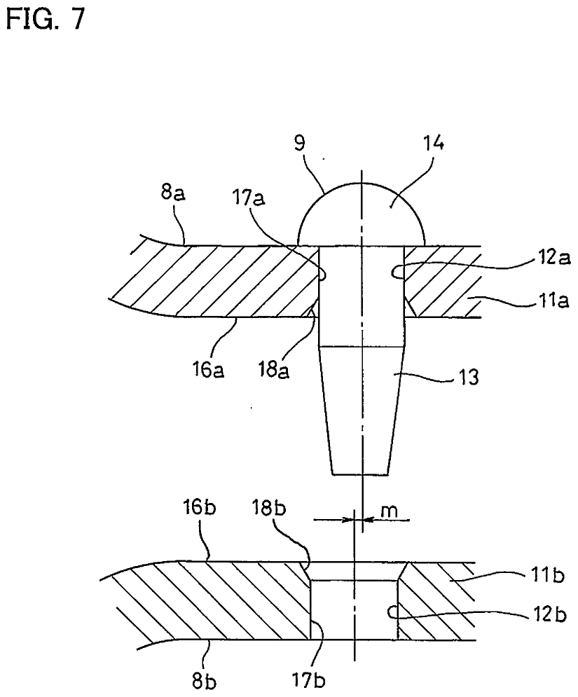

As illustrated in FIG. 4, in a state in which each rivet 9 has not been press-fitted in the first rivet hole 12a yet, the rivet 9 and the first rivet hole 12a are formed to satisfy the dimensional relationships A<C and C<B, where A is the outer diameter of the distal end of the rivet shaft 13, B is the outer diameter of the neck of the rivet shaft 13, and C is the inner diameter of the shear surface 17a of the first rivet hole 12a. Since the dimensional relationship C<B is satisfied, the neck of the rivet shaft 13 is fitted, with interference, to the shear surface 17a of the first rivet hole 12a. Also, since the dimensional relationship A<C is satisfied, even if, as illustrated in FIG. 7, when the distal end portion of the rivet shaft 13 is inserted into the second rivet hole 12b, there is a displacement m between the center of the rivet shaft 13 and the center of the second rivet hole 12b, the above insertion is easy. Also, the first rivet hole 12a is formed to satisfy L>2t/3, where L is the axial length of the shear surface 17a of the inner periphery of the first rivet hole 12a, and t is the thickness of the first flat plate portion 11a.

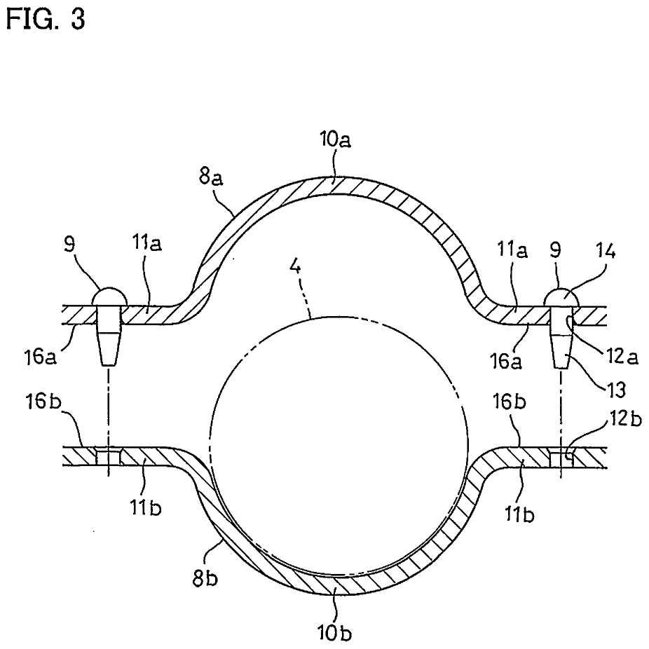

Thereafter, as illustrated in FIG. 3, a soft nitriding treatment is conducted to the rivets 9 and the first annular member 8a that are now integrally combined together due to press fitting. The “soft nitriding treatment” is a treatment for forming a nitrided layer (surface-hardened layer) on the surface of a steel, and for example, by heating a steel at a temperature lower than the transformation point (within the temperature range of about 400° C. to 590° C.) in a mixed gas atmosphere of ammonia gas and endothermic denaturing gas, nitrogen infiltrates into the surface of the steel, thereby forming a nitrided layer. By conducting a soft nitriding treatment, it is possible to improve the durability of the cage 5 without substantially changing the dimensions of the cage 5. By conducting a soft nitriding treatment, a nitrided layer is formed on the surface of the first annular member 8a, but the inner periphery of each first rivet hole 12a illustrated in FIG. 5 (fitting surface thereof to which the rivet shaft 13 is fitted) is masked by the rivet shaft 13, and thus has a non-nitrided surface formed with no nitrided layer.

Also, a soft nitriding treatment is conducted to the second annular member 8b which has not been coupled to the first annular member 8a yet as illustrated in FIG. 3. At this time, since each rivet 9 has not been inserted in the second rivet hole 12b of the second annular member 8b and the entire inner periphery of the second rivet hole 12b is exposed, a nitrided layer is formed on the entire inner periphery of the second rivet hole 12b.

Next, a plurality of balls 4 are placed between the inner ring 2 and the outer ring 3 illustrated in FIG. 1 so as to be circumferentially equidistantly spaced apart from each other, and the first annular member 8a and the second annular member 8b are superposed on each other such that each ball 4 is sandwiched from both axial sides by the first pocket wall portion 10a of the first annular member 8a and the second pocket wall portion 10b of the second annular member 8b illustrated in FIG. 3. At this time, the rivet shafts 13 partially protruding beyond the first annular member 8a are inserted into the respective second rivet holes 12b of the second annular member 8b.

Thereafter, as illustrated in FIG. 6, the portions of the rivet shafts 13 protruding beyond the respective second rivet holes 12b of the second annular member 8b are axially crushed and crimped (plastically deformed) by a crimping die (not shown), so that crimping heads 15 are formed and the first annular member 8a and the second annular member 8b are coupled together.

As illustrated in FIG. 10, the ball bearing 1 can be used as a bearing that supports a rotary shaft 20 of an automotive transmission 19. Instead of using the ball bearing 1 as a bearing for the rotary shaft 20 of the automotive transmission 19, the ball bearing 1 can be also used as a bearing that supports a rotary shaft of an automotive engine accessory; a bearing that supports a rotary shaft of a running motor of an electric vehicle such as a battery electric vehicle (EV) or a hybrid electric vehicle (HEV); or a bearing that supports a rotary shaft of a speed reducer that reduces the rotational speed of a running motor of an electric vehicle.

For this ball bearing 1, since, as illustrated in FIG. 5, each second rivet hole 12b, which axially extends through the second flat plate portion 11b, has an inner periphery constituted by a cylindrical shear surface 17b having a constant inner diameter that does not change in the axial direction; and a tapered fracture surface 18b that gradually radially expands from the shear surface 17b toward the abutment surface 16b, when each rivet shaft 13 is inserted into the second rivet hole 12b, the tapered fracture surface 18b functions as a guiding surface for the rivet shaft 13, thus facilitating the insertion of the rivet shaft 13 into the second rivet hole 12b. That is, even if, as illustrated in FIG. 7, when each rivet shaft 13 is inserted into the second rivet hole 12b, there is a displacement m between the center of the rivet shaft 13 and the center of the second rivet hole 12b, since the tapered fracture surface 18b functions as a guiding surface for the rivet shaft 13, the insertion of the rivet shaft 13 is easy. Therefore, the iron plate rivet crimping cage 5 has excellent assemblability.

Also, as illustrated in FIG. 5, by punching, with a punch, each second flat plate portion 11b from the side opposite from the abutment surface 16b toward the abutment surface 16b, it is possible to form a tapered fracture surface 18b that gradually radially expands toward the abutment surface 16b. Since, when the second rivet holes 12b are formed to axially extend through the respective second flat plate portions 11b, the tapered fracture surfaces 18b are simultaneously formed on the inner peripheries of the second rivet holes 12b, the number of machining steps is small and the cost is low compared to a case where chamfers are formed on the edges of the plural second rivet holes 12b that are closer to the abutment surfaces 16b.

Also, for this ball bearing 1, since the rivets 9 are press-fitted into the respective first rivet holes 12a of the first annular member 8a of which the surface has not been subjected to a soft nitriding treatment and hardened yet, the press fitting of the rivets 9 is easy. That is, compared to a case where a soft nitriding treatment is conducted to the first annular member 8a before press-fitting the rivets 9 into the first rivet holes 12a, and then the rivets 9 are press-fitted into the first rivet holes 12a, if, as in the above embodiment, the rivets 9 are press-fitted into the first rivet holes 12a before conducting a soft nitriding treatment to the first annular member 8a, and then a soft nitriding treatment is conducted to the first annular member 8a, since the rivets 9 are press-fitted into the first rivet holes 12a of the first annular member 8a of which the surface has not been hardened yet, the press fitting of the rivets 9 is easy.

Also, for this ball bearing 1, since, as illustrated in FIG. 4, the shear surface 17a of the inner periphery of each first rivet hole 12a has an axial length L that satisfies L>2t/3, where t is the thickness of the first flat plate portion 11a, when each rivet 9 is inserted into the first rivet hole 12a, it is possible to ensure a fitting area where the outer periphery of the rivet shaft 13 of the rivet 9 and the inner periphery of the first rivet hole 12a are fitted to each other with interference. Therefore, after each rivet 9 is press-fitted into the first rivet hole 12a as illustrated in FIG. 5, before the portion of the rivet shaft 13 of the rivet 9 protruding beyond the first rivet hole 12a is inserted into the second rivet hole 12b, it is possible to prevent pullout of the rivet 9 from the first rivet hole 12a due to, e.g., vibrations or shocks received from the outside.

The following table shows verification results of the relationship between the axial length L of the shear surface 17a and the rivet pullout safety factor against an impact load (evaluation value corresponding to the magnitude of the force by which the rivet 9 is pulled out of the first rivet hole 12a).

TABLE 1

| Axial length L | Rivet pullout safety factor |
|---|---|
| 1t | 1.71 |
| 2t/3 | 1.13 |
| 1t/3 | 0.58 |

The above results show that it is possible to prevent pullout of the rivet during transportation by setting the axial length L of the shear surface 17a so as to satisfy L>2t/3.

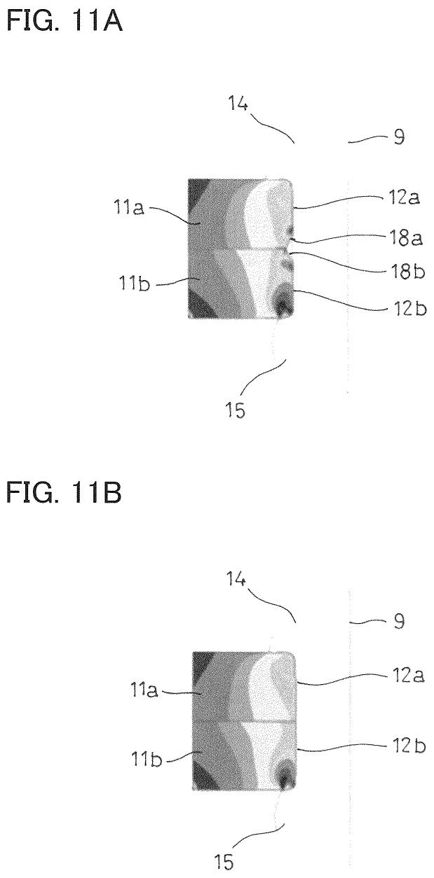

FIG. 11A illustrates analysis results of the stress acting on the first flat plate portion 11a and the second flat plate portion 11b in a case where the fracture surface 18a is disposed at an end of the first rivet hole 12a and the fracture surface 18b is disposed at an end of the second rivet hole 12b. Also, FIG. 11B illustrates analysis results of the stress acting on the first flat plate portion 11a and the second flat plate portion 11b in a case where the fracture surface 18a is not disposed at an end of the first rivet hole 12a and the fracture surface 18b is not disposed at an end of the second rivet hole 12b. As can be seen from the comparison of FIGS. 11a and 11b, there is no difference in the magnitude and distribution of the stress between a case where the fracture surfaces 18a and 18b are disposed and a case where the fracture surfaces 18a and 18b are not disposed. Therefore, it is considered that the strength of the cage is not reduced by forming the fracture surface 18a at an end of the first rivet hole 12a, and the fracture surface 18b at an end of the second rivet hole 12b.

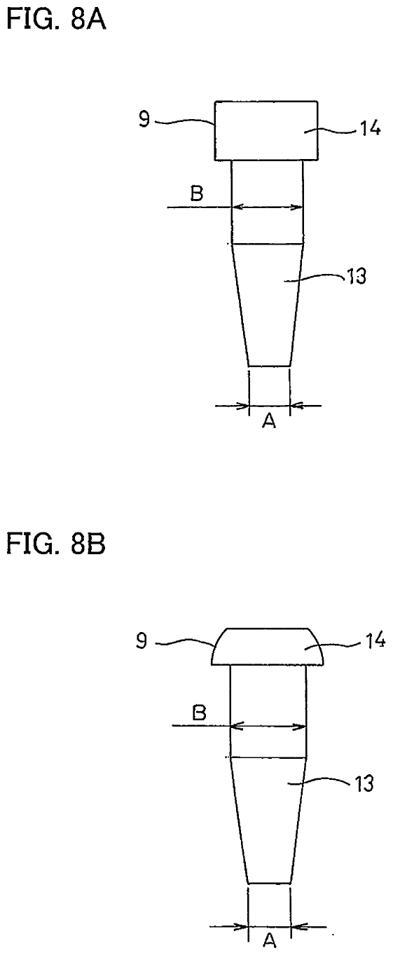

While, in the above embodiment, rivets 9 including a spherical crown-shaped pre-formed head 14 as illustrated in FIG. 4 are exemplified and described, rivets 9 including a cylindrical pre-formed head 14 as illustrated in FIG. 8A, or rivets 9 including a spherical segment-shaped pre-formed head 14 as illustrated in FIG. 8B may be used.

While, in the above embodiment, a hollow annular member having an inner ring raceway groove 7 in the outer periphery is exemplified and described as the inner ring 2, the inner ring 2 does not necessarily need to be a hollow annular member. For example, a solid member (shaft body) having an inner ring raceway groove 7 which is directly formed in the outer periphery and with which the balls 4 come into rolling contact may be used as the inner ring 2. In short, an inner member having, in the outer periphery, an annular inner ring raceway groove with which the balls come into rolling contact can be used as the inner ring.

While, in the above embodiment, a hollow annular member having an outer ring raceway groove 6 in the inner periphery is exemplified and described as the outer ring 3, the outer ring 3 does not necessarily need to be a hollow annular member. For example, a bearing housing having an outer ring raceway groove 6 which is directly formed in the inner periphery and with which the balls 4 come into rolling contact may be used as the outer ring 3. In short, an outer member having, in the inner periphery, an annular outer ring raceway groove with which the balls come into rolling contact can be used as the outer ring.

The above-described embodiment is a mere example in every respect, and the present invention is not limited thereto. The scope of the present invention is indicated not by the above description but by the claims, and should be understood to include all modifications within the meaning and scope equivalent to the scope of the claims.

### DESCRIPTION OF REFERENCE NUMERALS

1: Ball bearing
2: Inner ring
3: Outer ring
4: Ball
5: Iron plate rivet crimping cage
8a: First annular member
8b: Second annular member
9: Rivet
10a: First pocket wall portion
10b: Second pocket wall portion
11a: First flat plate portion
11b: Second flat plate portion
12a: First rivet hole
12b: Second rivet hole
13: Rivet shaft
14: Pre-formed head
15: Crimped head
16a, 16b: Abutment surface
17a, 17b: Shear surface
18a, 18b: Fracture surface
19: Transmission
20: Rotary shaft
L: Axial length of the shear surface
T: Thickness of the first flat plate portion

1. A ball bearing comprising:
an inner ring;
an outer ring arranged radially outwardly of, and coaxially with, the inner ring;
a plurality of balls disposed between the inner ring and the outer ring so as to be circumferentially spaced apart from each other; and
an iron plate rivet crimping cage retaining the balls,
wherein the iron plate rivet crimping cage includes:
a first annular member formed of a steel plate;
a second annular member formed of a steel plate, and axially opposed to the first annular member; and
a plurality of rivets coupling the first annular member and the second annular member together,
wherein the first annular member includes:
arc-shaped first pocket wall portions receiving the respective balls; and
first flat plate portions disposed to circumferentially alternate with the first pocket wall portions, and each having a first rivet hole axially extending through the first annular member, and,
wherein the second annular member includes:
arc-shaped second pocket wall portions receiving the respective balls; and
second flat plate portions disposed to alternate with the second pocket wall portions, and each having:
a second rivet hole axially extending through the second annular member; and,
an abutment surface against a corresponding one of the first flat plate portions, and
wherein each of the rivet includes:
a rivet shaft inserted through a corresponding one of the first rivet holes of the first flat plate portions and a corresponding one of the second rivet holes of the second flat plate portions;
a pre-formed head formed at one end of the rivet shaft, and axially engaged with the corresponding one of the first flat plate portions; and
a crimped head formed at the other end of the rivet shaft, and axially engaged with a corresponding one of the second flat plate portions, and
wherein each of the second rivet holes has an inner periphery constituted by:
a cylindrical shear surface having a constant inner diameter that does not axially change; and
a tapered fracture surface gradually radially expanding from the shear surface toward a corresponding one of the abutment surfaces of the second flat plate portions.

2. The ball bearing according to claim 1, wherein a nitrided layer is formed on a surface of the first annular member and a surface of the second annular member.

3. The ball bearing according to claim 2, wherein the nitrided layer is formed on the entire inner peripheries of the second rivet holes, and an inner periphery of each of the first rivet holes has a non-nitrided surface that is not formed with the nitrided layer.

4. The ball bearing according to claim 1, wherein the inner periphery of each of the first rivet holes is constituted by:
a cylindrical shear surface having a constant inner diameter that does not axially change; and
a tapered fracture surface gradually radially expanding from the shear surface of the first rivet hole toward a corresponding one of abutment surfaces of the first flat plate portions against the respective second flat plate portions, and
wherein L>2t/3 is satisfied, where L is an axial length of the shear surface of the inner periphery of the first rivet hole of each of the first flat plate portions, and t is a thickness of the each of the first flat plate portions.

5. The ball bearing according to claim 1, wherein the first annular member and the second annular member are formed of a cold-rolled steel plate.

6. The ball bearing according to claim 1, used as a bearing supporting a rotary shaft of one of an automotive transmission, an automotive engine accessory, a running motor of an electric vehicle and a speed reducer for reducing a rotational speed of a running motor of an electric vehicle.

7. The ball bearing according to claim 2, wherein the inner periphery of each of the first rivet holes is constituted by:
a cylindrical shear surface having a constant inner diameter that does not axially change; and
a tapered fracture surface gradually radially expanding from the shear surface of the first rivet hole toward a corresponding one of abutment surfaces of the first flat plate portions against the respective second flat plate portions, and
wherein L>2t/3 is satisfied, where L is an axial length of the shear surface of the inner periphery of the first rivet hole of each of the first flat plate portions, and t is a thickness of the each of the first flat plate portions.

8. The ball bearing according to claim 3, wherein the inner periphery of each of the first rivet holes is constituted by:
a cylindrical shear surface having a constant inner diameter that does not axially change; and
a tapered fracture surface gradually radially expanding from the shear surface of the first rivet hole toward a corresponding one of abutment surfaces of the first flat plate portions against the respective second flat plate portions, and
wherein L>2t/3 is satisfied, where L is an axial length of the shear surface of the inner periphery of the first rivet hole of each of the first flat plate portions, and t is a thickness of the each of the first flat plate portions.

9. The ball bearing according to claim 5, wherein the inner periphery of each of the first rivet holes is constituted by:
a cylindrical shear surface having a constant inner diameter that does not axially change; and
a tapered fracture surface gradually radially expanding from the shear surface of the first rivet hole toward a corresponding one of abutment surfaces of the first flat plate portions against the respective second flat plate portions, and
wherein L>2t/3 is satisfied, where L is an axial length of the shear surface of the inner periphery of the first rivet hole of each of the first flat plate portions, and t is a thickness of the each of the first flat plate portions.

10. The ball bearing according to claim 6, wherein the inner periphery of each of the first rivet holes is constituted by:
a cylindrical shear surface having a constant inner diameter that does not axially change; and
a tapered fracture surface gradually radially expanding from the shear surface of the first rivet hole toward a corresponding one of abutment surfaces of the first flat plate portions against the respective second flat plate portions, and
wherein L>2t/3 is satisfied, where L is an axial length of the shear surface of the inner periphery of the first rivet hole of each of the first flat plate portions, and t is a thickness of the each of the first flat plate portions.
